(19) United States
(12) Patent Application Publication
(10) Pub. No.: US 2014/0281951 A1
(43) Pub. Date: Sep. 18, 2014

(54) AUTOMATED COLLABORATIVE EDITOR

(71) Applicant: MICROSOFT CORPORATION, Redmond, WA (US)

(72) Inventors: Eran Megiddo, Redmond, WA (US); Peter Leonard, Redmond, WA (US)

(73) Assignee: Microsoft Corporation, Redmond, WA (US)

(21) Appl. No.: 13/827,196

(22) Filed: Mar. 14, 2013

(51) Int. Cl. G06F 17/21

(52) U.S. Cl. CPC G06F 17/211
USPC 715/271

(57) ABSTRACT

On computing devices, the implementation as a service or as a hosted application responsive to user intent automatically allows for correction of grammatical and stylistic issues in collaboratively or individually created content. The performance of automated fact-checking provides users with amended data and quotations along with the source, based on search engine input. Focused and automation rich productivity solutions provide benefits when an understanding of user intent is available.

### BACKGROUND

Content processing applications and services, especially textual content, provide a number of controls for selecting, modifying aspects of content such as formatting, grammatical or stylistic corrections, even word replacements through synonym/antonym suggestions. In typical systems, such controls are available individually, sometimes independently or interdependently. Thus, users may be enabled to select and modify aspects of content they create or process, but they have to do it manually.

Furthermore, creating content to match a particular style (not necessarily formatting, but prose style) is mostly a manual process left to the user in conventional applications. For example, if an organization has a particular preference for not only formatting, but also choice of words, sentence structure, and similar aspects of documents created by its members, it may be a process left to individual users to learn and apply the organization's preferences.

Frustrations potentially experienced by users in creating and editing content to match predefined criteria may be aggravated in collaborative environments, where content may be created and processed by multiple users simultaneously and/or sequentially.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to automated editing functionality in an application or service through which content may be processed providing features like automated conversion of textual content to one voice (style, format, even content adjustments), natural language use in interaction and processing, format modifications such as date/currency adjustments, analysis of who has been editing the content and how, and combination of individual portions of work into a team output. In addition to correction of grammatical and stylistic errors in the created work, citations may be provided. In some examples, automated fact-checking may be performed providing users with corrected facts, quotations, and similar ones along with the source. Edited content may be in various forms such as word processing documents, presentation documents, spreadsheets, and comparable ones. Notifications and analysis results may be provided through various communication means, such as email, text messages, publication to social/professional networks, blogs, and similar means.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes a conceptual diagram illustrating a local and networked configuration environment, where an automated collaborative content editor may be implemented;

FIG. 2 illustrates a screenshot of an example user interface for automated fact-checking according to embodiments;

FIG. 3 illustrates a screenshot of an example user interface allowing for changes to be made by team members to a user, allowing for collaborative work to be accomplished:

FIG. 4 illustrates a screenshot of an example user interface allowing for collaborative content by individual participants to be coalesced into a collective work;

FIG. 5 illustrates a screenshot of an example user interface where content may be automatically edited;

FIG. 6 illustrates a screenshot of an example user interface allowing for user options on selected portions of content;

FIG. 7 is a networked environment, where a system according to embodiments may be implemented;

FIG. 8 is a block diagram of an example computing operating environment, where embodiments may be implemented; and

FIG. 9 illustrates a logic flow diagram for a process of automatically editing content for achieving uniform and/or desired voice for the content according to embodiments.

### DETAILED DESCRIPTION

As briefly described above, an automated editing functionality in an application or service may enable automated conversion of textual content to one voice (style, format, even content adjustments), natural language use in interaction and processing, format modifications such as date/currency adjustments, analysis of who has been editing the content and how, and combination of individual portions of work into a team output. Automated fact-checking may be performed with citation and providing users with corrected facts, quotations, and similar ones along with the source.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for automated content editing functionality. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

Referring to FIG. 1, conceptual diagram 100 illustrates a local and networked configuration environment, where embodiments may be implemented. The computing devices and computing environments shown in diagram 100 are for illustration purposes. Embodiments may be implemented in various local, networked, and similar computing environments employing a variety of computing devices and systems.

Diagram 100 represents local computing environment in a computing device 106, where a content processing application may enable one or more users such as users 114 to create and process content individually or collaboratively. The content processing application may be executed as a locally installed application on a desktop computer 104, a laptop computer 106, a tablet 108, a smart phone 116, a smart whiteboard 102, and similar devices. The content processing application may also be part of a hosted service executed on a server 110 and accessed by client devices through a network 112.

The content processing application may provide an automated editing functionality with features like automated conversion of textual content to one voice, natural language use in interaction and processing, format modifications such as date/currency adjustments, analysis of who has been editing the content and how, and combination of individual portions of work into a team output. In some examples, automated fact-checking may be performed with citations providing users with corrected facts, quotations, and similar ones along with the source. Notifications and analysis results on the processed content may be provided through various communication means, such as email, text messages, publication to social/professional networks, blogs, and similar means.

The content processing application may be a word processing application, a presentation application, a spreadsheet application, a note taking application, a collaboration application with a content editing module, and comparable ones.

The example systems in FIG. 1 have been described with specific servers, client devices, applications, and interactions. Embodiments are not limited to systems according to these example configurations. A platform providing automated content editing may be implemented in configurations employing fewer or additional components and performing other tasks. Furthermore, specific protocols and/or interfaces may be implemented in a similar manner using the principles described herein.

Referring to FIG. 2, screenshot 200 illustrates an example user interface for automated fact-checking according to embodiments. A content processing application according to embodiments may enable, among other things, automated fact-checking one or more of, but not limited to, dates, places, names, quotations, numeric values such as population, economic facts, formulas, and so on. Automated fact-checking may provide users with corrected facts and/or quotations, along with the source, based on a search engine input.

As shown in screenshot 200, a user interface for a content processing application may display the created/processed content with controls 206 for formatting, fact-checking, and comparable content processing tasks. In some embodiments, the content processing application may be part of a hosted service and accessed by a user through a thin or thick client application such as a browser. In the latter case, the user may simply enter the uniform resource locator (URL) 204 of the particular service with their identification and access the application. The user's identity 202 may also be displayed on the user interface. In case of collaborative editing, other users working on the same content may be displayed too.

In response to detecting highlighting of a portion 208 of the content, the application may present a view pane 210 with results from a search engine showing fact-checking results for the highlighted portion 208 of the content. In other embodiments, the fact-checking may be completely automatic, where the application may determine factual portions of the content such as dates, places, names, quotations, numeric values such as population, economic facts, formulas, and so on, and perform the fact-checking and correction without the user actively indicating the factual portions. Citations for corrected facts may be provided in a separate pane such that the user can import them into the content document as formal citations or automatically inserted into the document according to the document's citation convention. Moreover, changes or corrections may be emphasized for the user to review employing a color scheme, a highlighting scheme, and/or other formatting schemes such as using bold/italic font, etc.

The browser user interface shown in the screenshot 200 is for illustration purposes. In addition to standard elements such as an address of the current web page, a search box, command menus, and a tab indicating the web page, other elements may be provided in various locations and in any order using the principles described herein.

Referring to FIG. 3, a screenshot 300 illustrates an example user interface allowing for changes to be made by team members, allowing for collaborative work on creating and/or modifying content. In a collaborative environment, individual participants' work may be combined into team output, adjusting a voice (style, language, format, and even the content itself) of the content for unity and/or compliance with organizational or desired norms. Consistency (e.g., correct use) for verbs, prepositions, hyperlinks, entities, places, people, acronyms, dates, references. etc. may be automatically accomplished. Analysis of individual contributions and individual edits may be performed and results of who has been editing the content and how may be provided to collaborators through email or similar communication means, as well as publication to social/professional networks, blogs, and similar methods. Individually edited content may be presented as a collaboratively created product to a group leader or collaborator. Natural language may be employed in interaction and processing. In addition to touch and gesture based input, other input mechanisms such as conventional keyboard/mouse input, voice commands, eye-tracking, and similar ones may be accepted.

In the example scenario of diagram 300, a sociology paper 302 is being collaboratively created by a team. The user interface indicates to a current user 306 that the document was updated as of one hour ago (304). In addition to displaying the processed content 308, the user interface presents indications 310 of which collaborator provided what input and when such as additions, deletions, modifications along with a representation of each collaborator. Furthermore, the changes made by the collaborators may be displayed in detail for the current user 306 to view (e.g., an added paragraph, an added image, and so on). The information associated with the collaborators and modified content may be hidden/presented based on current user's choice (e.g., toggling of a control on the user interface).

Referring to FIG. 4, a screenshot 400 illustrates an example user interface allowing for collaborative works by individual participants to be combined into a team input, showing which individual contributed each part to the final collaborative work. In a content processing application according to embodiments, a user may be enabled to select a portion of content 406 within presented content 408 and see who among the collaborators has processed the selected portion of content 406 through a collaboration pane 404.

The collaboration pane 404 may display representations (e.g., images or icons) of the collaborators along with their names and also provide additional information such as when they processed the selected portion of content and what they did. In addition to a standard editing toolbar 410, a collaboration toolbar 402 may be provided for performing collaboration tasks such as viewing a particular collaborator's contributions, communicating with one or more collaborators, and similar tasks.

In some embodiments, a date, time, currency, number system, and similar formatting aspects may be automatically adjusted to a user's locale for uniform usage. Grammatical and stylistic issues in the collaboratively created work may be corrected and citations may be provided. Individual contributor's style, format, and content of text may be adjusted for collaboration unity or to achieve a single voice. Consistency of grammatical elements, hyperlinks, entities, places, people, acronyms, dates, references, etc. may also be edited for achieving the single voice.

Style may be applied based on previously used styles by team members, organizational style requirements, and standardized styles. The styles to be applied may be determined by inference (e.g., “edu” domain for the collaborative team may indicate and educational institution). Styles and other changes may be suggested to the user(s) based on content (e.g., scholarly article, marketing brochure, and so on). In other embodiments, a table of contents, references, and a list of authors for the collaboration may be automatically provided.

Referring to FIG. 5, a screenshot 500 illustrates an example user interface where content may be automatically edited for various aspects. While the user interface in diagram 500 is one of a hosted content processing service accessed through a browser, a content processing application according to embodiments may also be a service accessed through a thick client or a locally installed application.

Changes, corrections, potential problems, etc. associated with created and/or processed content may be highlighted or similarly emphasized. Created and/or processed content may include textual content, images, graphics, embedded objects, and similar content. While style and format changes typically apply to textual content, similar adjustments may also be performed on other types of content. For example, size, location, coloring, shading, etc. of images or graphics, controls presented for embedded objects (e.g., play controls for audio or video objects) may be selected/modified for consistency with the determined/inferred voice of the content.

In the example scenario shown in diagram 500, textual formatting changes on the presented content 508 include re-formatting of titles 504 and automatic indentation 510. Changes automatically applied by the content processing application may be shown to the user through tooltips or similar indications. In some embodiments, color/highlighting, shading, and/or textual schemes may be employed to emphasize the changes.

Diagram 500 further illustrates change to an image 506. Images may be examined/upgraded for fidelity, adjusted for fit into work style (size, shape, placement), and so on. The change to the image 506 (e.g., sizing, coloring, shading, placement, etc.) may be emphasized through graphical elements. For example, image 506 may be resized to fit available space and the resizing may be emphasized through arrows or a dashed frame 512 indicating to the user that a change was applied to the displayed image.

Referring to FIG. 6, a screenshot 600 illustrates an example user interface allowing for user options on select portions of processed content. As shown in FIG. 5 and discussed above, automatically applied changes to content may be emphasized to make users aware of the corrections/adjustments for achieving a uniform/desired voice for a document. A content processing application according to embodiments may include, but is not limited to, word processing applications, presentation applications, note taking applications, spreadsheet applications, and collaboration applications. Such applications may automatically select, edit, and apply language of content in addition to adjusting other aspects of content such as style, formatting, etc.

In the example embodiment shown in diagram 600, options provided to the user upon highlighting of a portion 602 of the displayed content 608 in an options menu 604 are illustrated. For example, a user may be enabled to comment on the highlighted portion, insert a note (e.g., for the collaborators) associated with the highlighted portion, or assign the highlighted portion to a collaborator. Additional information may also be presented such as which collaborator last edited the highlighted portion. The user may also be enabled to view a complete history of edits on the highlighted portion 602 of the displayed content 608.

In some embodiments, the user may be enabled to select desired options through a touch or gesture action 606. For enhanced collaboration on the content, invitation, assignment, presence information about authors, real-time co-authoring, private work, and commenting may be enabled through a user-friendly interface. Notifications and analysis results may be provided through email or a similar communication means, as well as publication to social or professional networks or blogs, among other methods. Furthermore, learning algorithms may be used to dynamically adjust the processing.

The examples in FIG. 1 through 6 have been described with specific user interface elements, configurations, and presentations. Embodiments are not limited to systems according to these example configurations. Automated editing of content may be implemented in configurations using other types of user interface elements, presentations, and configurations in a similar manner using the principles described herein.

FIG. 7 is an example networked environment, where embodiments may be implemented. A system determining a desired/uniform voice for created content and applying changes automatically to achieve that voice may be implemented via software executed over one or more servers 706 such as a hosted service. The platform may communicate with client applications on individual computing devices such as the desktop computer 104, laptop computer 106, smart phone 116, and tablet 108 (‘client device’) through network(s) 714.

Client applications executed on any of the client devices may facilitate communications with hosted content processing applications executed on servers 706, or on individual server 704. A content processing application executed on one of the servers may facilitate determination of style, formatting, content, and other changes, automatic application of the changes, and collaboration with change tracking as discussed above. The content processing application may retrieve relevant data from data store(s) 716 directly or through database server 702, and provide requested services to the user(s) through the client devices.

Network(s) 714 may comprise any topology of servers, clients, Internet service providers, and communication media. A system according to embodiments may have a static or dynamic topology. Network(s) 714 may include secure networks such as an enterprise network, an unsecure network such as a wireless open network, or the Internet. Network(s) 714 may also coordinate communication over other networks such as Public Switched Telephone Network (PSTN) or cellular networks. Furthermore, network(s) 714 may include short range wireless networks such as Bluetooth or similar ones. Network(s) 714 provide communication between the nodes described herein. By way of example, and not limitation, network(s) 714 may include wireless media such as acoustic, RF, infrared and other wireless media.

Many other configurations of computing devices, applications, data sources, and data distribution systems may be employed to implement a platform responsive to individual user intent and directed to an automated editing functionality. Furthermore, the networked environments discussed in FIG. 7 are for illustration purposes only. Embodiments are not limited to the example applications, modules, or processes.

FIG. 8 and the associated discussion are intended to provide a brief, general description of a suitable computing environment in which embodiments may be implemented. With reference to FIG. 8, a block diagram of an example computing operating environment for an application according to embodiments is illustrated, such as the computing device 106. In a basic configuration, computing device may be any computing device with communication capabilities, and include at least one processing unit 812 and a system memory 804. The computing device 800 may also include a plurality of processing units that cooperate in executing programs. Depending on the exact configuration and type of computing device, a system memory 804 may be volatile (such as RAM), non-volatile (such as ROM, flash memory, etc.) or some combination of the two. The system memory 804 typically includes an operating system 805 suitable for controlling the operation of the platform, such as the WINDOWS®, WINDOWS MOBILE®, or WINDOWS PHONE® operating systems from MICROSOFT CORPORATION of Redmond, Wash. The system memory 804 may also include one or more software applications such as collaboration application 822 and editing module 824.

The collaboration application 822 may determine through analysis, inference, or other methods a uniform/desired voice for content being created or processed. The collaboration application 822 through the editing module 824 may then determine needed style, formatting, etc. changes, perform fact-checking, and apply the changes automatically presenting the user(s) options to accept or reject the changes, as well as track each other's collaboration efforts on the content. The collaboration application 822 and the configuration module 824 may be separate applications or integrated modules of a hosted service. This basic configuration is illustrated in FIG. 8 by those components within a dashed line 802.

The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage 814 and a non-removable storage 816. Computer readable storage media may include volatile and nonvolatile, removable and non-removable media implemented in any method or technology for storage of information, such as computer readable instructions, data structures, program modules, or other data. The system memory 804, removable storage 814 and the non-removable storage 816 are all examples of computer readable memory device. Computer readable memory devices include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical medium which can be used to store the desired information and which can be accessed by the computing device 800. Any such computer readable storage media may be part of the computing device 800. The computing device 800 may also have the input device(s) 818 such as keyboard, mouse, pen, voice input device, touch input device, an optical capture device for detecting gestures, and comparable input devices. An output device(s) 820 such as a display, speakers, printer, and other types of output devices may also be included. These devices are well known in the art and need not be discussed at length here.

Some embodiments may be implemented in a computing device that includes a communication module, a memory device, and a processor, where the processor executes a method as described above or comparable ones in conjunction with instructions stored in the memory device. Other embodiments may be implemented as a computer readable memory device with instructions stored thereon for executing a method as described above or similar ones. Examples of memory devices as various implementations of hardware are discussed above.

The computing device 800 may also contain communication connections 822 that allow the device to communicate with other devices 826, such as over a wired or wireless network in a distributed computing environment, a satellite link, a cellular link, a short range network, and comparable mechanisms. Other devices 826 may include computer device(s) that execute communication applications, web servers and the comparable device 108. Communication connection(s) 822 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

FIG. 9 illustrates a logic flow diagram for a process 900 of automatically editing content for achieving uniform and/or desired voice for the content according to embodiments. The process 900 may be implemented on a server or other computing device.

The process 900 begins with an operation 902, where a uniform and/or desired voice for content may be determined based on user input, predefined parameters, or inference. At operation 904, the content may be analyzed for elements that do not match the uniform/desired voice such as stylistic, grammatical, formatting, language, and/or content elements.

At operation 906, fact-checking may be performed on factual portions of content such as dates, places, names, quotations, numeric values such as population, economic facts, formulas, and so on. At operation 908, changes to elements detected as non-compliant with the determined voice for the content and changes based on the fact-checking may be applied. In some embodiments, citations may also be inserted.

At operation 910, the applied changes may be emphasized through a coloring, highlighting, shading, or textual scheme to alert the user about the changes and give the user an option to accept or reject the changes. In other embodiments, collaborative efforts on the content such as additions, deletions, modification, and comments may be tracked and presented for an enhanced collaborative experience. Collaborators may be enabled to communicate within a context of the content (e.g., through notes, comments, and other forms of exchanges).

The operations included in the process 900 are for illustration purposes. Automatic editing content for achieving uniform and/or desired voice for the content may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for automatically editing content to provide a uniform and desired voice to the content, the method comprising:
determining a uniform and desired voice for the content;
analyzing the content for elements that are non-compliant with the determined voice;
determining modifications to the non-compliant elements;
applying the modifications to the non-compliant elements; and
emphasizing the applied modifications in the content to enable a user to one of accept and reject the applied modifications, wherein natural language is employed in interactions with the user.

2. The method of claim 1, wherein determining the uniform and desired voice for the content comprises determining one or more of style elements, grammatical elements, formatting elements, a language, and portions of the content based on one or more of a user input, a predefined parameter, and an inference.

3. The method of claim 1, wherein analyzing the content for the elements that are non-compliant with the determined voice comprises analyzing consistency and correct use of one or more of verbs, subjects, prepositions, hyperlinks, entities, places, people, acronyms, dates, and references.

4. The method of claim 1, wherein applying the modifications to the non-compliant elements comprises automatically adjusting one or more of a date format, a currency, and a numbering format to the user's locale and for uniform usage.

5. The method of claim 1, further comprising:
determining factual information in the content;
performing fact-checking for the determined factual information; and
correcting factual information found to be incorrect as a result of the fact-checking.

6. The method of claim 5, wherein the factual information includes one or more of a date, a place, a name, a quotation, a numeric value, an economic fact, and a formula.

7. The method of claim 5, further comprising employing a search engine to perform the fact-checking.

8. The method of claim 5, further comprising inserting a citation associated with corrected factual information.

9. The method of claim 1, wherein applying the modifications to the non-compliant elements comprises further includes employing one of: a textual scheme, a coloring scheme, a shading scheme, and a graphical element to emphasize the applied modification.

10. The method of claim 1, wherein determining the uniform and desired voice for the content includes one or more of:
analyzing at least one of previously used styles by team members, organizational style requirements, and standardized styles;
analyzing a type of the content; and
inferring the voice from one or more of the user's affiliation, the user's organization, and a collaboration environment.

11. A computing device for automatically editing content to provide a uniform and desired voice to the content, the computing device comprising:
a memory;
a processor coupled to the memory, the processor executing a content processing application, wherein the content processing application is configured to:
determine a uniform and desired voice for the content;
analyze the content for elements that are non-compliant with the determined voice;
determine modifications to the non-compliant elements;
apply the modifications to the non-compliant elements;
track collaborative efforts on the content by individual collaborators;
emphasize the collaborative efforts and the applied modifications in the content enabling the collaborators to view the applied modifications and individual contributions; and
enable the collaborators to communicate within a context of the content.

12. The computing device of claim 11, wherein the content elements include one or more of textual content, an image, a graphic, an embedded audio object, and an embedded video object and the modifications are applied based on one or more of one or more of style elements, grammatical elements, formatting elements, a language, and portions of the content.

13. The computing device of claim 11, wherein the content processing application is further configured to provide one or more of a notification, an analysis result, an invitation, an assignment, presence information about the collaborators, a real-time co-authoring capability, a comment, a time and type of contribution by each collaborator through one or more of a notice on a user interface displaying the content, an email, a text message, a publication to a social network, a publication to a professional network, and a publication to a blog.

14. The computing device of claim 11, wherein the content processing application is further configured to combine the collaborators' individual contributions to a team output applying the uniform and desired voice.

15. The computing device of claim 11, wherein the collaborators are enabled to interact with the content processing application through one or more of a touch input, a gesture input, a keyboard input, a mouse input, a pen input, a voice command, and an eye tracking input.

16. The computing device of claim 11, wherein the content processing application is one of: a locally installed application and a hosted service, and the computing device is one of: a server, a desktop computer, a laptop computer, a tablet, a smart whiteboard, and a smart phone.

17. A computer-readable memory device with instructions stored thereon for automatically editing content to provide a uniform and desired voice to the content, the instructions comprising:
determining a uniform and desired voice for the content;
analyzing the content for elements that are non-compliant with the determined voice;
determining modifications to the non-compliant elements;
applying the modifications to the non-compliant elements;
determining factual information in the content;
performing fact-checking for the determined factual information; correcting factual information found to be incorrect as a result of the fact-checking; and
emphasizing the applied modifications and the corrected factual information in the content to enable a user to one of accept and reject the applied modifications and the corrected factual information.

18. The computer-readable memory device of claim 17, wherein the instructions further comprise employing a learning algorithm to dynamically adjust application of the uniform and desired voice and the fact-checking.

19. The computer-readable memory device of claim 17, wherein the instructions further comprise one or more of a table of contents, references, and a list of authors.

20. The computer-readable memory device of claim 17, wherein the instructions further comprise modifying one or more of:
a style, a grammar, a formatting, and a language of textual content;
a fidelity, a size, a shape, and a placement of an image and a graphic; and
a size, a placement, and a control associated with an embedded object.
